(19) United States
(12) Patent Application Publication
(10) Pub. No.: US 2010/0156080 A1
(43) Pub. Date: Jun. 24, 2010

(54) Vehicle capture and restraint device

(76) Inventor: Kenneth L. Napier, Charlestown, IN (US)

Correspondence Address: David W. Carrithers;CARRITHERS LAW OFFICE, PLLC, Suite 206, 6200 Dutchman's Lane, Louisville, KY, 40205, US

(21) Appl. No.: 12/317,461

(22) Filed: Dec. 23, 2008

(51) Int. Cl. B60D 1/04

(52) U.S. Cl. 280/762

(57) ABSTRACT

A device designed to be used on a police pursuit vehicle to hook and restrain another fleeing vehicle. The device is carried within or attached to the front bumper of the pursuit vehicle. The attachment mechanism can be spring powered, pneumatically or hydraulically or electrically operated to deploy the hook. A hook device can be mounted on either the left side or right side of the front bumper of the pursuit vehicle or mounted to both sides of the bumper. The hook is deployed in a telescoping fashion from the end of the bumper so that it hooks into the sheet metal and at least one frame member behind the rear fender well of the fleeing vehicle. Once the device deploys and cuts in to the sheet metal and underlying structure of the fleeing vehicle, the brakes are applied on the pursuit vehicle, and the fleeing vehicle is brought to a stop and remains securely restrained by the pursuit vehicle.

### TECHNICAL FIELD

The present invention relates to the field of security devices used on police cars, law enforcement vehicles, and military vehicles wherein apparatus can be deployed from a moving pursuit vehicle for attachment to a moving pursued vehicle for apprehending and restraining the pursued vehicle.

### BACKGROUND OF THE INVENTION

Various devices have been devised for use as vehicle apprehension devices. In U.S. Pat. No. 7,168,906 by Weatherford for “Police Car Vehicle Restraint” issued on Jan. 30, 2007, teaches a device is mounted on the front of a police vehicle which can lower at least one hook to a level which allows the police vehicle to move the hook under the rear of a fleeing vehicle after which time the hook is rotated up hooking into the bumper or other structural members of the vehicle. With the hook holding the fleeing vehicle, the police vehicle brakes to a stop to restrains the fleeing vehicle. However, problems occur if the fleeing vehicle is swerving back and forth making the alignment and approach dangerous or if the fleeing vehicle is heavier than the police vehicle or the fleeing vehicle suddenly stops further endangering the lives of the officers in the pursuit vehicle. The same problems occur with using U.S. Pat. No. 5,839,759 by Trigo for a “Vehicle Capture Device” teaches a hinged fork lift including tines which fold down from the bumper of the pursuit vehicle to lift the rear of the fleeing vehicle off of the ground.

U.S. Pat. No. 2,107,312 for “Attachment for Apprehending Motor Vehicles” by Thompson issued on Feb. 8, 1938 and teaches a device which provides a plunger mechanism in combination with a pair of jaws which contacts the fleeing vehicle's rear bumper and causes and an upper and a lower hook to grip the fleeing vehicle whereupon the police vehicle can now brake both vehicles to a stop and continue to restrain the fleeing vehicle upon stopping. Two weaknesses can be noted in this design. First, rear bumpers on today's vehicle are protected by a plastic or fiber glass skirt and trim and do not extend outwardly from the frame rails of the vehicle preventing the hooks from enclosing the bumper. Also, not all bumpers are at the same height. This height difference may prevent the plunger mechanism from contacting the bumper surface at all.

U.S. Pat. No. 3,284,101 by Arnold for a “Telescoping Bumper Clamping Tow Bar for Vehicles” teaches a means for securing a vehicle for towing. U.S. Pat. No. 2,157,612 is similar to the aforementioned '312 patent except that the jaws do not work in combination with a plumber and merely grip a bumper extending spaced apart from the frame. U.S. Patent Publication 2005/0017491 published on Jan. 27, 2005 by Mein for an “Extendable Arm for a Motor Vehicle” teaches a telescoping arm which extends from the bumper of the pursuit vehicle to the window of the vehicle which has been pulled over in order to obtain information and data from the occupants of the stopped vehicle in a safe manner. Finally, U.S. Patent Publication 2006/0186702 published Aug. 24, 2006 by Kisanuki et al. For a “Collision Behavior Control Apparatus” teaches an arm extending from the front bumper from the center toward the side to push people out of the way and to the side of the vehicle in order that the people will not be run over.

The police often find themselves in situations where a fleeing vehicle must be stopped by force by a chasing vehicle. One known method is to try to shoot the tires of the fleeing vehicle in order to reduce the control of the vehicle and its ability to flee. Another known method is to force the fleeing vehicle to stop by driving the chasing vehicle to the side or in front of it or, in suitable road conditions, to push the fleeing vehicle from the back corner so that its driver loses control of the vehicle and the vehicle goes off the road. When any one of these means is used, the chasing vehicle must go beside or past the fleeing vehicle, and both the chasing and the fleeing party commit themselves to serious danger. The chasing vehicle can often suffer serious damage.

### SUMMARY OF THE INVENTION

The purpose of the invention is to provide an entirely new method and equipment for stopping vehicles by force, while avoiding the above-mentioned disadvantages and risks to a large extent.

The present invention comprises an extendable hook and hold device for attachment to a moving vehicle to stop and restrain same. The extendable hook gripping means of the car hook device connected to the front bumper of the chasing vehicle is driven into the sheet metal structure on the rear quarter panel of the vehicle to be stopped so that a fixed contact is provided between the cars. In one preferred embodiment, the gripping means contains a tip which penetrates the sheet metal and underlying structure. After this is accomplished, the chase vehicle is brought to a stop along with the fleeing vehicle. This method is much safer than puncturing the tires of a fleeing vehicle, setting up barricades in the road, or lifting the rear of the fleeing vehicle off of the ground which may result in loss of control for both the pursuit an fleeing vehicle.

For instance, in one scenario, the police cruiser comes along side toward the rear quarter panel of the fleeing vehicle and deploys the hook from the end of the car hook assembly by pushing an activation switch. The power for deployment can be supplied electrically, pneumatically, hydraulically or by spring action. The car hook can be used by one car and its driver. It is a component in a front bumper replacement unit or can be attached to the existing bumper and/or frame of the police cruiser. It can be deployed from its rest position from the driver's compartment by the driver during the chase.

Thus, it is an object of this invention to provide a device which can safely apprehend and restrain a fleeing vehicle.

It is also an object of this invention to provide a car hook device which will not add a large amount of weight or obstruct the view of the driver.

It is another object of this invention to provide a car hook device which is both effective and simple to use.

It is an object of the present invention to provide a hidden hook means nested within a cavity of the front bumper or in close proximity thereto.

It is an object of the present invention to enable a pursuit vehicle to activate the hook means by driving near the side of a fleeing vehicle.

It is an object of the present vehicle to provide a resusable device.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a cross sectional top view of the car hook assembly with the car hook retracted into the box metal housing in transport mode;

FIG. 2 is a cross sectional top view of the car hook assembly with the left side car hook extending out from the box metal housing in its deployed state, employing a spring as a prime mover;

FIG. 3 is a cross sectional top view of the left side portion of the car hook assembly with the car hook extending out from the box metal housing in its deployed state, employing an electric motor driven rack and pinion as a prime mover;

FIG. 4 is a cross sectional top view of the right side portion of the car hook assembly with the car hook extending out from the box metal housing in its deployed state, employing an electric motor driven worm gear drive as a prime mover; and

FIG. 5 is a cross sectional top view of the car hook assembly with the left side car hook extending out from the box metal housing in its deployed state, employing an air or a hydraulically driven cylinder as a prime mover.

### DESCRIPTION OF THE PREFERRED EMBODIMENTS

In accordance with the present invention, there is provided a device which can be installed onto a police chase vehicle and then be used to catch, ensnare, bring to a stop and restrain a fleeing vehicle.

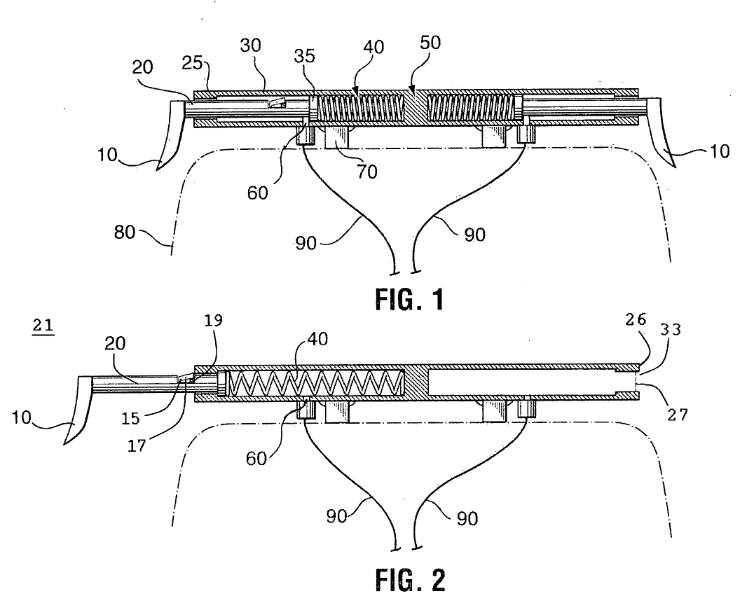

FIG. 1 shows a pair of car hook assemblies extending from a central mounting point 51 onto the front bumper of a pursuit vehicle 80 by the use of structural elements such as bolts, welds, rivets or any other rigid attaching means 70. Of course, a single unit could be utilized for either the right or left side of the bumper to function independently as well.

A longitudinal tubular member such as a cylinder or box tube defines a barrel 30 having a first diameter bore 31 which contains a spring means 40 of corresponding length and width enabling the spring means to be compressed and expanded therein by a plunger head 35 mounted onto the distal end of a shaft 21. The plunger head 35 has a diameter which is slightly less than the diameter of the barrel 31 allowing for a sliding reciprocating movement of the shaft 21 wherein the plunger head 35 aids in alignment of the shaft 21 within the bore 31.

The inside diameter of the second diameter bore 33 extending through the distal end 26 of the longitudinal member 30 results in the distal end of the barrel 30 being thicker due to a further reduction in a second internal diameter 27 of a selected portion of the barrel 30 which is slightly larger than the diameter of the shaft 21 connecting to a hook member wherein the shaft 21 slidably mounts therein. A shoulder 25 is created at the point where the diameter of the barrel changes. The shoulder 25 provides an abutment or stop when contacted by the plunger head 35 upon extension of the shaft 21. The diameter of the plunger head 35 within the first bore 31, and the diameter of the shaft 21 within the second bore 33 provide lateral support to car hook 20 extending into position. An inner lip Shoulder 25 acts as a stop against shoulder 35 when spring 40 pushes car hook 20 to its outer limit.

As shown in the illustrations, the longitudinal tubular member 30 includes a stop means comprising an interior abutment defining an intermediate central wall 50 providing a rigid attaching point for one end of the spring means 40. Of course, it is contemplated that a rib, projection, or even a bolt extending through a hole drilled normal to the surface of the longitudinal tubular member 30 would also provide an attachment point or interior wall to anchor the compression means for driving the hook. The distal end of the plunger head 35 abuts the spring means 40 and compresses the spring means 40 against the wall 50 to produce tension on the spring 40.

As shown the spring means comprises at least one coil spring; however, it is contemplated that an actuator, pneumatic piston, or liquid piston could also be compressed to store the energy required to move the hook means which extends from a shaft 20 which includes a head 35

In FIG. 1, trigger pin 60 extends into tube 30 and against shoulder 35 to hold car hook 20 rigidly inside tube 30. As shown in FIG. 2, a cable 90 pulling a cable withdraws the trigger pin 60 and releases spring 40 launching the hook means from the tubular member 30. This allows the compressed spring 40 to forcefully extend car hook 20 outward. The sharp point 10 protrudes into the sheet metal of the rear quarter panel of a fleeing vehicle (not shown) and lodges in a frame member at which time the pursuit vehicle 80 applies braking force and both vehicles are brought to a stop. The preferred hook member 10 comprises a pointed projection extending rearward at about a 90 degree angle from the shaft 21 wherein the hook curves outwardly slightly which facilitates snagging the tip into the sheet metal of the fleeing vehicle and allows for easy removal of the tip by moving the pursuant vehicle forward slightly when disengaging the hook.

FIG. 1 shows a working car hook mechanism on each side of the assembly. The police vehicle operator has the choice of which side to use and therefore, which cable to pull.

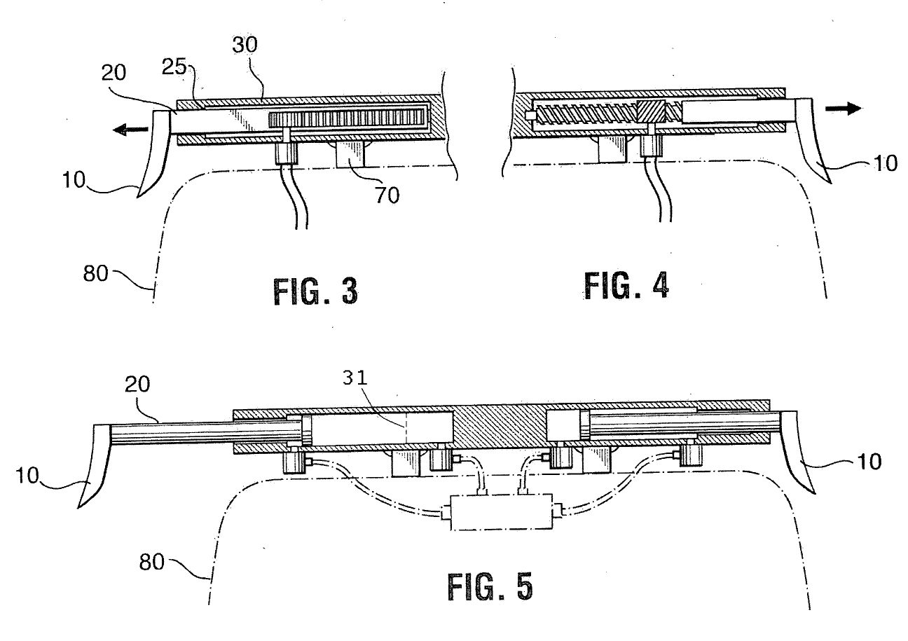

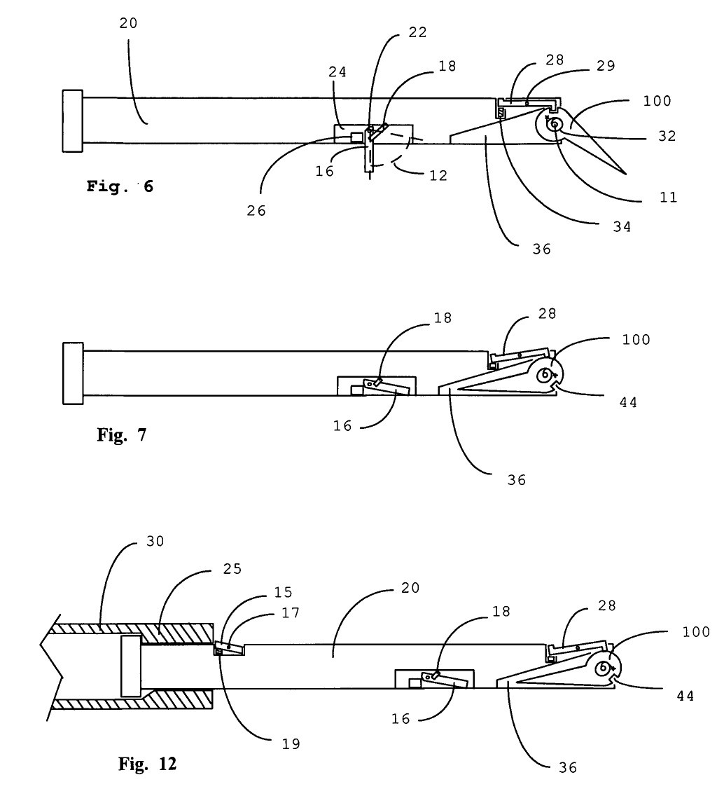

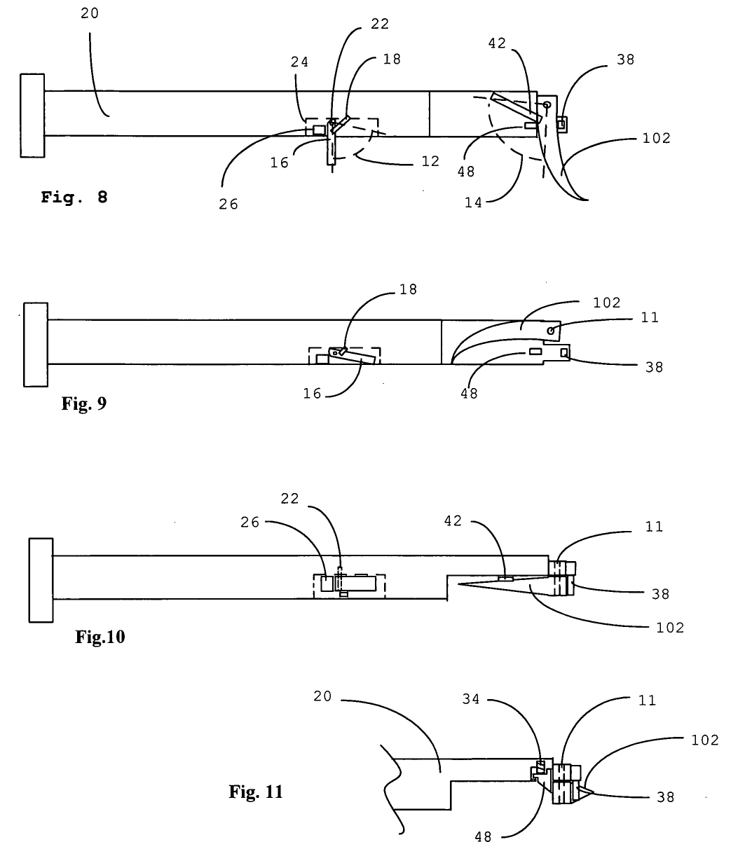

As shown in FIGS. 3-5, another preferred embodiment of the present invention uses a remotely operated pneumatic or hydraulic cylinder as shown in FIG. 5 instead of the spring 40 and trigger mechanism 60 to extend and retract the car hook 20. Other embodiments can use an electrical motor driven rack and pinion as in FIG. 3, or an electric motor driven worm gear drive shown in FIG. 4 as a prime mover. Still other embodiments can employ round tubular steel shapes rather than box metal construction.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A car hook assembly attached to the front of a chase vehicle for use in apprehending and restraining a fleeing vehicle comprising:
a box metal tubular section attached horizontally to the front of a chase vehicle;
a car hooking portion telescoping horizontally in or out of said tubular section with a sharp rigid hook fabricated on the outer end of said car hooking portion pointing toward the rear of the chase vehicle but canted slightly away from said chase vehicle;
shoulders on the inside of said tubular section and the inner end of said car hooking portion restraining said car hooking portion when deployed; and
car hook deployment means within said tubular section.

2. The device defined in claim 1 wherein said deployment means comprises a spring and triggering mechanism which is remotely triggered from inside said chase vehicle.

3. The device defined in claim 1 wherein said deployment means comprises a pneumatic cylinder remotely controlled from inside said chase vehicle.

4. The device defined in claim 1 wherein said deployment means comprises a hydraulic cylinder remotely controlled from inside said chase vehicle.

5. The device defined in claim 1 wherein said deployment means comprises an electrically operated rack and pinion mechanism remotely controlled from inside said chase vehicle.

6. The device defined in claim 1 wherein said deployment means comprises an electrically operated worm gear drive mechanism remotely controlled from inside said chase vehicle.

7. A car hook assembly attached to the front of a chase vehicle for use in apprehending and restraining a fleeing vehicle comprising:
a metal tubular section of round or roughly rounded cross section attached horizontally to the front of a chase vehicle;
a car hooking portion telescoping horizontally in or out of said tubular section with a sharp rigid hook fabricated on the outer end of said car hooking portion pointing toward the rear of the chase vehicle but canted slightly away from said chase vehicle;
shoulders on the inside of said tubular section and the inner end of said car hooking portion restraining said car hooking portion when deployed; and
car hook deployment means within said tubular section.

8. The device defined in claim 7 wherein said deployment means comprises a spring and triggering mechanism which is remotely triggered from inside said chase vehicle.

9. The device defined in claim 7 wherein said deployment means comprises a pneumatic cylinder remotely controlled from inside said chase vehicle.

10. The device defined in claim 7 wherein said deployment means comprises a hydraulic cylinder remotely controlled from inside said chase vehicle.

11. The device defined in claim 7 wherein said deployment means comprises an electrically operated rack and pinion mechanism remotely controlled from inside said chase vehicle.

12. The device defined in claim 7 wherein said deployment means comprises an electrically operated worm gear driven mechanism remotely controlled from inside said chase vehicle.
